(19) United States
(12) Patent Application Publication
(10) Pub. No.: US 2025/0334766 A1
(43) Pub. Date: Oct. 30, 2025

(54) FIBER OPTIC CASSETTE WITH CABLE MANAGER AND SYSTEM

(71) Applicant: BELDEN CANADA ULC, SAINT-LAURENT (CA)

(72) Inventors: Moise LEVY, LAVAL (CA); Luc MILETTE, MONTREAL (CA); Christian ROA-QUISPE, LAVAL (CA); Dwayne CRAWFORD, Point-Claire (CA)

(73) Assignee: BELDEN CANADA ULC, SAINT-LAURENT (CA)

(21) Appl. No.: 19/263,145

(22) Filed: Jul. 8, 2025

Related U.S. Application Data
(63) Continuation of application No. 18/051,159, filed on Oct. 31, 2022, now Pat. No. 12,353,039.
(60) Provisional application No. 63/263,314, filed on Oct. 29, 2021.

(51) Int. Cl. G02B 6/44; G02B 6/38

(52) U.S. Cl. CPC G02B 6/4453; G02B 6/3885; G02B 6/4471; G02B 6/44715

(57) ABSTRACT

A fiber optic cassette may include a cassette portion comprising a plurality of optic fiber receptacles arranged along a front thereof and a multifiber receptacle along a back thereof opposite the first end, the front and back defining a cable assembly receiving region there between, and a plurality of optic fibers. Each of the optic fibers may be terminated at a first end by one of the receptacles and all of the plurality of optic fibers terminated at a second end the multifiber receptacle. In an embodiment, a casing may be molded over a middle portion of each of the plurality of optic fibers and received within the cable assembly receiving region. In a particular embodiment, the cassette may be reversible and may comprise a reversible securing portion that is configured to be secured on either side of the cassette portion.

### BACKGROUND TO RELATED APPLICATIONS

This application is a continuation of U.S. application Ser. No. 18/051,159, filed Oct. 31, 2022, pending, which claims the benefit under 35 USC § 119(e) of U.S. provisional application No. 63/263,314, filed on Oct. 29, 2021, both of which are incorporated herein in their entireties by reference.

### FIELD OF THE INVENTION

The present invention relates to a fiber optic cassette with cable manager and system. In particular, the present invention relates to a reversible fiber optic cassette with over-molded cable manager.

### BACKGROUND TO THE INVENTION

The prior art discloses modular cassettes. One drawback of such cassettes is that the optic fibers are placed freely within the cassette body and susceptible to damage and the like.

### SUMMARY OF THE INVENTION

The present addresses the above and other drawbacks by providing a fiber optic cassette arrangeable on a tray comprising a plurality of cassette engaging features. The cassette comprises a cassette body comprising a plurality of optic fiber receptacles arranged along a front end, a multifiber receptacle along a back end and a pair of opposed side edges connecting the front end and the back end, a plurality of optic fibers, each of the optic fibers terminated at a first end by a respective one of the receptacles and all of the plurality of optic fibers terminated at a second end by the multifiber receptacle, and a reversible securing member. The front, back and the opposed side edges together define a cable assembly receiving region. The second ends are encased in a cable jacket. A casing is lower pressure molded over a free end of the cable jacket and a middle portion of each of the plurality of optic fibers. The first ends stand free of and are equally spaced along a first casing end and the second ends stand free of a second casing end opposite the first casing end. A pair of parallel slot-like apertures are molded in the casing towards a center thereof. A main part of the reversible securing member is configured to fit sideways across the cassette body towards a center thereof, the main part comprising a first surface and a second surface opposite the first surface. A plurality of pairs of opposed flexible fingers extend away from the first surface and are configured for releasable engagement in respective slots in the side edges of the cassette body, one of each of the pairs of fingers positioned along each outer side edge of the main part. A pair of opposed casing engaging fingers are positioned towards a center of the main part extending at right angles away from the first surface and are configured for insertion into a corresponding one of the pair of parallel slot-like apertures molded in the casing. A tray engaging feature extending from the second surface is positioned off center of the main part and configured for engaging with one of the cassette engaging features. An actuator extends from a flexible end of the tray engaging feature through one of a pair of like apertures in the casing, one of the like apertures on either side of the pair of parallel slot-like apertures, the actuator for selectively disengaging the tray engaging feature from an engaged one of the cassette engaging features. The reversible securing element is secureable on either side of the cassette body by inserting the flexible fingers in respective ones of the outward facing slots while the casing engaging fingers are inserted into respective ones of the slot-like apertures and such that a free end of each of the fingers engages an outer surface of the casing holding the casing against the first surface and the actuator through an aligned one of the pair of like apertures. When the reversible securing member is mounted on a first side of the cassette body, the actuator is actuatable from a second side of the cassette body.

There is also provided a fiber optic cassette arrangeable on a tray comprising a plurality of cassette engaging features. The cassette comprises a cassette body comprising a plurality of optic fiber receptacles arranged along a front thereof and a multifiber receptacle along a back thereof opposite the front and a pair of opposed side edges connecting the front and the back, and a plurality of optic fibers, each of the optic fibers terminated at a first end by one of the receptacles and all of the plurality of optic fibers terminated at a second end the multifiber receptacle. The front, back and the opposed side edges together define a cable assembly receiving region. A tray engaging feature configured for engaging with one of the cassette engaging features extends away from the cable assembly receiving region. A casing is molded over a middle portion of each of the plurality of optic fibers. The first ends stand free of and are equally spaced along a first end of the casing and the second ends stand free of a second end of the casing opposite the first casing end. A casing engagement extends into the cable assembly receiving region for retaining the casing within the cable assembly receiving region.

Also, there is provided a fiber optic cassette comprising a cassette body comprising a plurality of optic fiber receptacles arranged along a front thereof and a multifiber receptacle along a back thereof opposite the front, the front and back defining a cable assembly receiving region there between, and a plurality of optic fibers. Each of the optic fibers terminated at a first end by one of the receptacles and all of the plurality of optic fibers terminated at a second end the multifiber receptacle. A middle portion of each of said plurality of optic fibers is within a casing and received within the cable assembly receiving region.

### BRIEF DESCRIPTION OF THE DRAWINGS

FIG. 1 provides raised right perspective view of a reversible fiber optic cassette with cable manager and tray in accordance with an illustrative embodiment of the present invention;

FIG. 2A provides a raised right front exploded perspective view of a reversible fiber optic cassette with cable manager in accordance with an illustrative embodiment of the present invention;

FIG. 2B provides a lowered left rear exploded perspective view of a reversible fiber optic cassette with cable manager in accordance with an illustrative embodiment of the present invention;

FIG. 2C provides a raised right front partially exploded perspective view of a reversible fiber optic cassette with cable manager detailing installation of a reversible securing element and in accordance with an illustrative embodiment of the present invention;

FIG. 3A comprises a raised right front exploded perspective view of a fiber optic cassette with cable manager in accordance with an alternative illustrative embodiment of the present invention;

FIG. 3B comprises a raised right front perspective view of a fiber optic cassette with cable manager in accordance with an alternative illustrative embodiment of the present invention;

FIG. 3C comprises a lowered left rear perspective view of a fiber optic cassette with cable manager in accordance with an alternative illustrative embodiment of the present invention; and

FIG. 3D comprises a raised left rear perspective view of a fiber optic cassette with cable manager in accordance with an alternative illustrative embodiment of the present invention.

### DETAILED DESCRIPTION OF THE ILLUSTRATIVE EMBODIMENTS

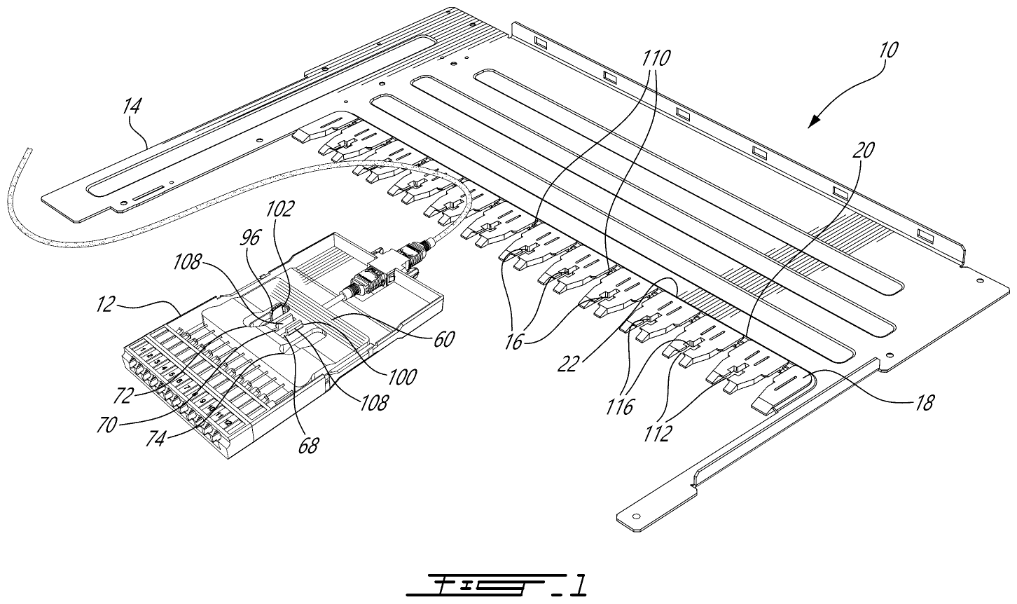

Referring now to FIG. 1, a fiber optic cassette with cable manager, generally referred to using the reference numeral 10, will now be described. The cassette and system 10 comprises one or more cassettes 12 which are releasably mounted to a tray 14 comprising a plurality of cassette engaging features 16. The tray 14 is typically slideably mounted with other trays in a case which is dimensioned for securing in a 19″ inch rack or the like (both not shown). The cassette engaging features 16 are illustratively molded as a strip 18 from a rigid material such as plastic and mounted on a forward edge 20 of the tray 14. The strip 18 is assembled to the forward edge 20 of the tray 14 by inserting the forward edge 20 in the rearward edge 22 of the strip 18 until the strip 18 is engaged by the tabs or the like (not shown) thereby securing the strip 18 to the tray 14.

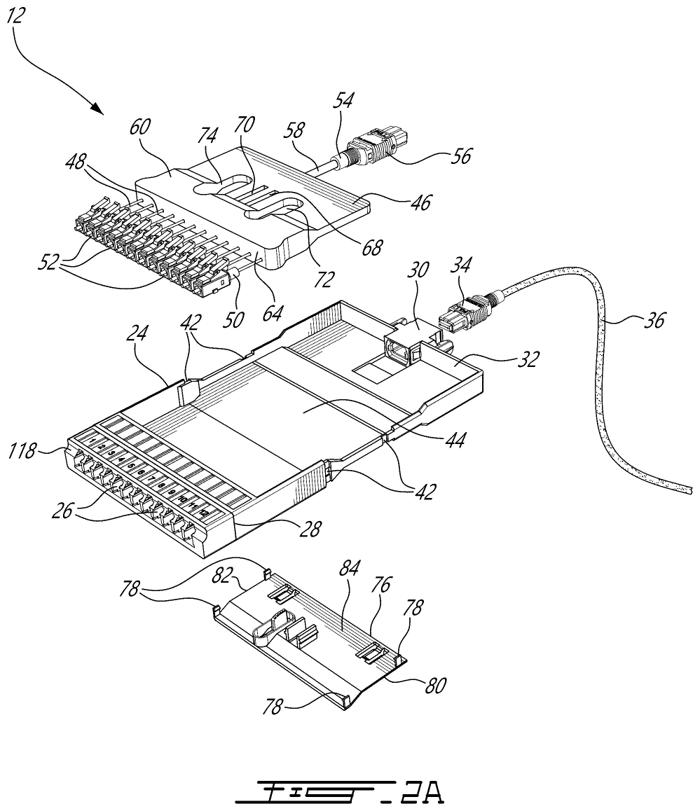

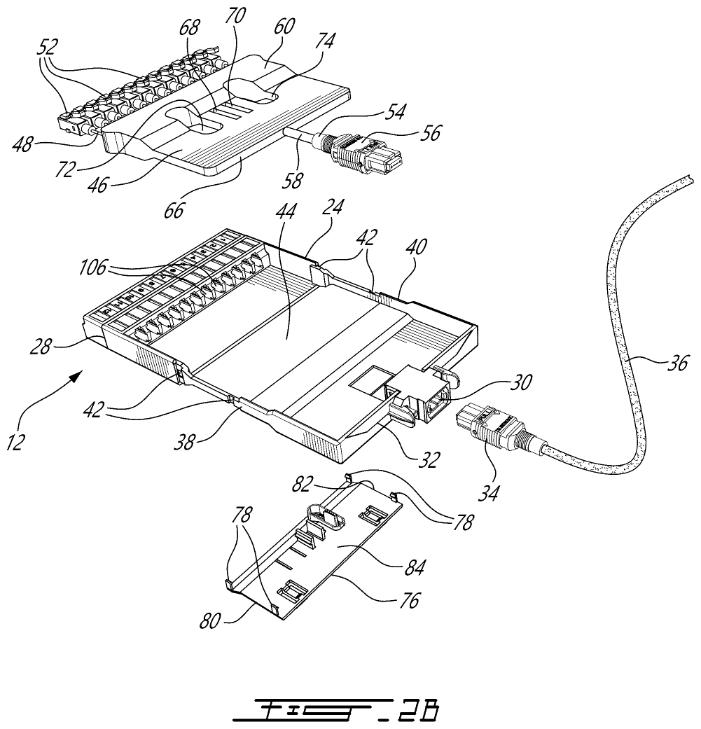

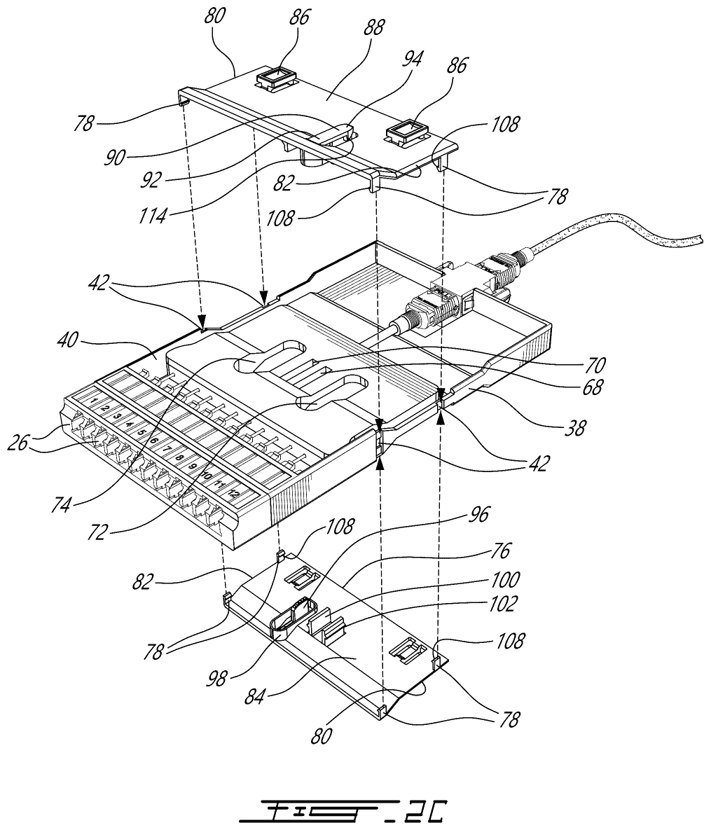

Referring to FIGS. 2A and 2B, each cassette 12 comprises a cassette body 24 comprising a plurality of optic fiber receptacles 26 arranged along a front 28 of the cassette body 24 and a multifiber receptacle 30 arranged along a back 32 of the cassette body 24 opposite the front end. In an embodiment the optic fiber receptacles 26 are configured for receiving a standard LC type plug for example terminating a single fiber optic cable or the like (both not shown). Additionally, in an embodiment the spacing between the optic fiber receptacles 26 is such that any two optic fiber receptacles 26 can receive two plugs (also not shown) in a duplex configuration. In an embodiment the multifiber receptacle 30 is a back-to-back receptacle configured for receiving on an outside a standard MPO type plug 34 terminating a 12× multi-fiber cable 36 or the like.

Still referring to FIGS. 2A and 2B, the cassette body 24 further comprises a pair of opposed outer side edges 38, 40 interconnecting the front 28 and the back 32 of the cassette body 24. Referring to FIG. 2C, each of the side edges 38, 40 comprises a pair of outward facing slots 42 therein. Together, the front 28, back 32 and side edges 38, 40 define a cable assembly receiving region 44 there between.

Still referring to FIGS. 2A and 2B, the cassette 12 further comprises an over-molded cable assembly 46 which is dimensioned to fit within the cable assembly receiving region 44. The cable assembly 46 comprises a plurality of optic fibers 48 each terminated at a first end 50 by a plug 52. In an embodiment the plug 52 is an LC type plug and dimensioned to fit into a standard LC type receptacle. The optic fibers 48 are each additionally terminated at a second end 54 by a multifiber plug 56 such as a standard MPO type plug which is dimensioned to fit into a standard MPO type receptacle. The second ends 54 are illustratively encased in a cable jacket 58. A casing 60 is molded over an open end of the cable jacket 58 and middle portions (not shown) of each of the optic fibers 48. In this regard, the middle portions of the optic fibers 48 are placed in a mold (not shown) comprising the desired outer shape of the casing 60 and the mold filled with a suitable plastic, for example using Low Pressure Molding (LPM) techniques or an epoxy, plastine, mastic or the like. The over-molding is such that the first ends 50 and their respective plugs 52 stand free of and are equally spaced along a first end 64 of the molded casing 60 and the second ends 54 stand free of a second end 66 of the casing 60 opposite the first housing end 64. Additionally, a pair of parallel slot-like apertures 68, 70 are molded in the casing 60 towards a center thereof and a pair of like oval apertures 72, 74 are molded in the casing 60, one of the like apertures 72, 74 on either side of the pair of parallel slot-like apertures 68, 70.

Referring to FIG. 2C in addition to FIGS. 2A an 2B, in an embodiment a removable and reversible securing element 76 is also provided which comprises a main part dimensioned to fit sideways across the cassette body 24. The securing element 76 comprises pairs of opposed flexible fingers 78 positioned along respective outer edges 80, 82 of the securing element 76 and extending away from a first surface 84 thereof. Additionally, there are provided a pair of stabilizing tabs 86 extending away from a second surface 88 of the securing element 76. The reversible securing element 76 further comprises a tray engaging feature 90 comprising a fixed end 92 and a flexible end 94 extending from the second surface 88 of the reversible securing element 76. An actuator 96 is further provided which extends from the flexible end 94 through an aperture 98 in the reversible securing element 76. Additionally, a pair of opposed housing engaging fingers 100, 102 are provided positioned towards a center of the reversible securing element 76 and extending at right angles away from the first surface 86.

Referring back to FIG. 1 in addition to FIG. 2C, in one embodiment the cassette 12 is assembled by attaching the securing element 76 to a selected side of the cassette body (as will be discussed in more detail below). The cable assembly 46 is then attached to the securing element 76 by inserting the housing engaging fingers 100, 102 into respective ones of the pair of parallel slot-like apertures 68, 70 in the casing 60. Hook features 104 on the outer ends of each of the housing engaging fingers 100, 102 engage an outer surface of the housing, thereby securing the casing 60 against the first surface 84 of the securing element 76. Additionally, the actuator 96 is inserted through an aligned one of the oval like apertures 72, 74. As a person of ordinary skill in the art will now understand, once assembled the actuatable surface of the actuator 96 is accessible from the accessible side of the cassette 12 when the cassette 12 is installed on the tray 14.

Referring to FIG. 2B in addition to FIG. 2C, as the casing 60 is assembled to the securing element 76, the plugs 52 are inserted into respective ones of a plurality of receptacles 106 illustratively molded inside the front 28 of the cassette body 24. Each of the receptacles 106 is in a back-to-back relationship with a respective one of the receptacles 26 arranged along the front 28 of the cassette body 24 and such that the optic fiber 48 terminated by one of the plugs 52 and inserted into a receptacle 106 is aligned for optical communication with an optic fiber terminated by a plug (both not shown) inserted into a respective one of the receptacles 26 arranged along the front 28 of the cassette body 24. Additionally, the multifiber plug 56 is inserted into the multifiber receptacle 30 on an inside thereof.

Still referring to FIG. 2C, the reversible securing element 76 is mountable to a selected side of the cassette body 24 and such that the cassette 12 is in a configured orientation (both mounting options are shown in FIG. 2C, although a person of ordinary skill in the art will understand that only one option is useable at a time) by aligning the flexible fingers 78 with respective ones of the outward facing slots 42 and inserting the flexible fingers 78 into the outward facing slots 42. Hook features 108 on the outer ends of the flexible fingers 78 engage with the opposed outer side edges 38, 40 thereby removably securing the reversible securing element 76 to the cassette body 24.

Referring again to FIG. 1 in addition to FIG. 2C, on insertion of the cassette 12 onto the tray 14 in its configured orientation, the stabilizing tabs 86 are engaged by respective ones of a plurality of slots 110 in the strip 18 while the actuator 96 is slid into a slot 112 in the selected cassette engaging feature 16 and a hook 114 on the flexible end 94 of the tray engaging feature 90 moves into an aperture 116 in the cassette engaging feature 16. A person of ordinary skill in the art will now understand that the hook 114 is biased into the aperture 116 by the flexible end 94 and such that the cassette 12 is securely held to the tray 14. Similarly, in order to release the cassette 12 from the tray 14, the actuator 96 is depressed thereby forcing the hook 114 out of the aperture 116 in the cassette engaging feature 16 thereby allowing the cassette 12 to be retracted from the tray 14.

Referring back to FIGS. 2A and 2B, in an embodiment the receptacles 26 are molded together as a block 118, illustratively a block 118 of twelve (12) LC type receptacles. Similarly, an inside of the front 28 comprises a plurality of receptacles 106 molded or otherwise formed therein. In an embodiment, the receptacles 106 are configured for receiving a standard LC type plug (not shown) for example terminating a single fiber optic cable or the like. The block 118 of receptacles 26 is attached to the front 28 for example by sonic welding, a suitable adhesive or the like.

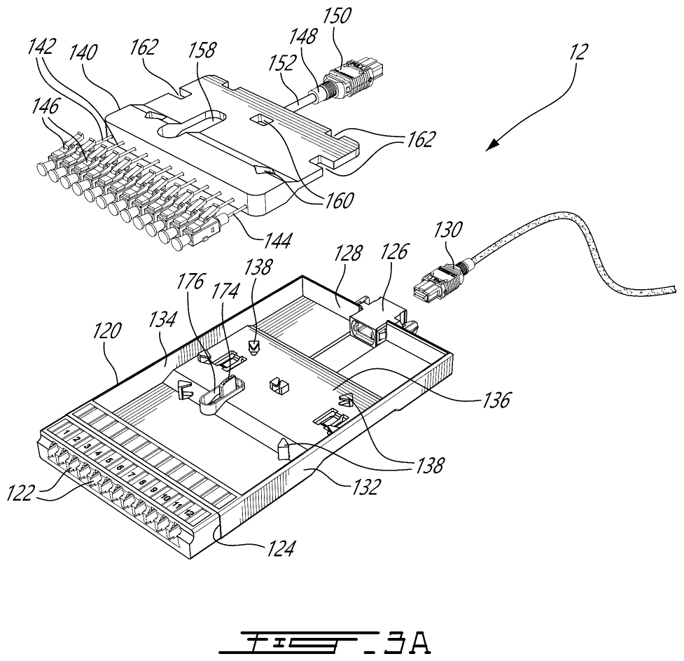

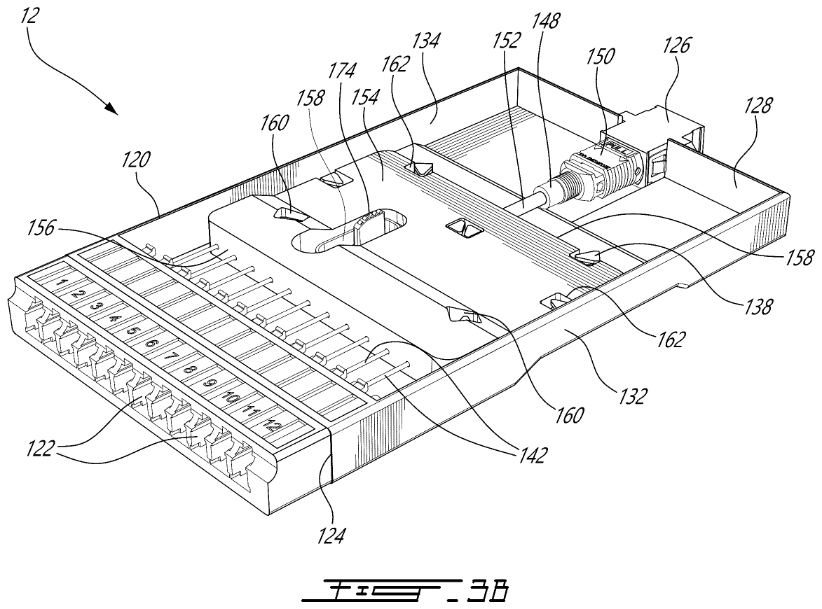

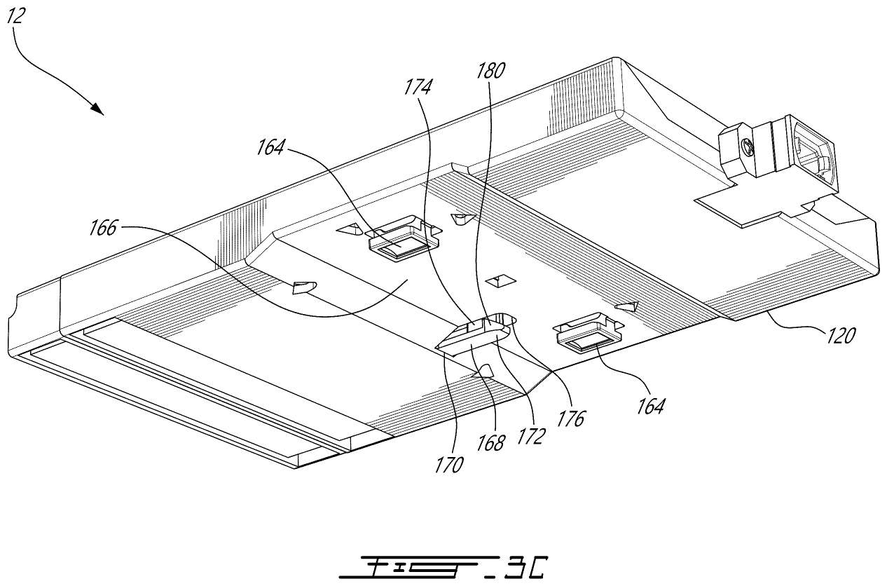

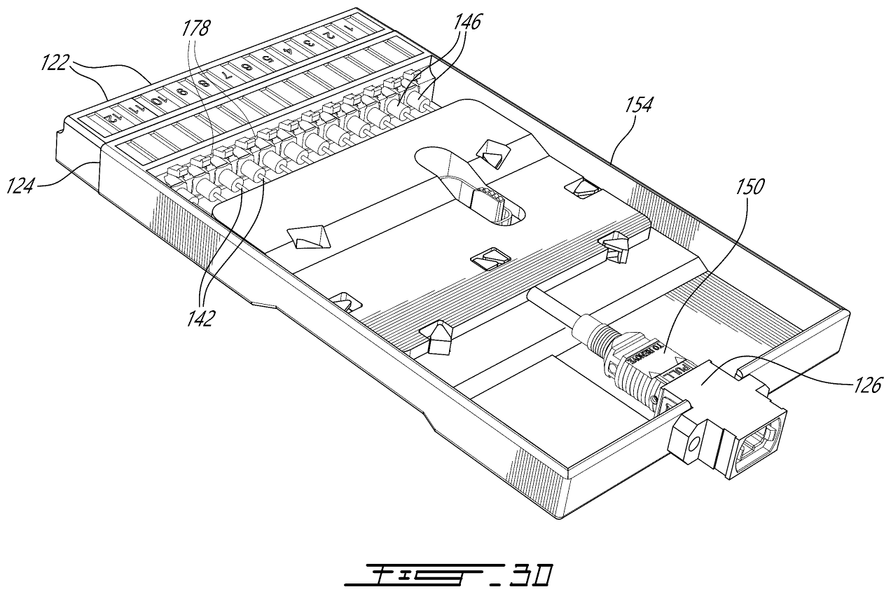

Referring now to FIGS. 3A and 3B, in an alternative embodiment, the cassette 12 is not reversible. Each cassette 12 comprises a cassette body 120 comprising a plurality of optic fiber receptacles 122 arranged along a front 124 of the cassette body 120 and a multifiber receptacle 126 arranged along a back 128. In an embodiment the optic fiber receptacles 122 are configured for receiving a standard LC type plug for example terminating a single fiber optic cable or the like (both not shown). Additionally, in an embodiment the spacing between the optic fiber receptacles 122 is such that any two optic fiber receptacles 122 can receive two plugs (also not shown) in a duplex configuration. In an embodiment the multifiber receptacle 126 is a back-to-back receptacle configured for receiving on an outside a standard MPO type plug 130.

Still referring to FIGS. 3A and 3B, the cassette body 120 further comprises a pair of opposed side edges 132, 134 interconnecting the front 124, back 128 and bottom of the cassette body 120. Together, the front 124, back 128, side edges 132, 134 and bottom define a cable assembly receiving region 136. In one embodiment, tabs 138 are provided within the cable assembly receiving region 136 on a first surface of the bottom for receiving loose fibre optic cables (not shown).

Still referring to FIGS. 3A and 3B, the cassette 12 further comprises an over-molded cable assembly 140 which is dimensioned to fit within the cable assembly receiving region 136. The over-molded cable assembly 140 comprises a plurality of optic fibers 142 each terminated at a first end 144 by a plug 146. In an embodiment the plug 146 is an LC type plug and dimensioned to fit into a standard LC type receptacle. The optic fibers 142 are each additionally terminated at a second end 148 by a multifiber plug 150 such as a standard MPO type plug which is dimensioned to fit into a standard MPO type receptacle. The second ends 148 are illustratively encased in a cable jacket 152. A housing 154 is molded over an open end of the cable jacket 152 and middle portions (not shown) of each of the optic fibers 142, as discussed above, for example, using Low Pressure Molding (LPM) techniques. The over-molding is such that the first ends 144 and their respective plugs 146 stand free of and are equally spaced along a first end 156 of the molded housing 154 and the second ends 148 stand free of a second end 158 of the housing 154 opposite the first housing end 156. Additionally, an oval actuator receiving aperture 158 is molded in the housing 154 as well as a plurality of tab receiving apertures 160 and tab receiving cut-outs 162.

Referring to FIG. 3C in addition to FIGS. 3A an 3B, in the alternative embodiment a pair of stabilizing tabs 164 are provided extending away from a second surface 166 of the bottom of the a cassette body 120. A tray engaging feature 168 comprising a fixed end 170 and a flexible end 172 extending from the second surface 166 of the bottom of the a cassette body 120 is also provided. An actuator 174 is further provided which extends from the flexible end 172 through an aperture 176 in the bottom of the a cassette body 120.

Still referring to FIGS. 3A, 3B and 3C, in the alternative embodiment the cassette 12 is assembled by placing the over-molded cable assembly 140 in the cable assembly receiving region 136 while the actuator 174 is aligned with and inserted into the oval apertures 158 in the housing 154. As a person of ordinary skill in the art will now understand, once assembled the actuatable surface of the actuator 174 is accessible from the accessible side of the cassette 12 when the cassette 12 is installed on the tray.

Referring to FIG. 3D in addition to FIG. 3C, as the housing 154 is assembled to into the cable assembly receiving region 136, the plugs 146 are inserted into respective ones of a plurality of receptacles 178 illustratively molded inside the front 124 of the cassette body 120. Each of the receptacles 178 is in a back-to-back relationship with a respective one of the receptacles 122 arranged along the front 124 of the cassette body 120 and such that the optic fiber 142 terminated by one of the plugs 146 and inserted into a receptacle 178 is aligned for optical communication with an optic fiber terminated by a plug (both not shown) inserted into a respective one of the receptacles 122 arranged along the front 124 of the cassette body 120. Additionally, the multifiber plug 150 is inserted into the multifiber receptacle 126 on an inside thereof.

Referring again to FIG. 1 in addition to FIG. 3C, on insertion of the cassette 12 onto the tray 14 in its configured orientation, the stabilizing tabs 164 are engaged by respective ones of a plurality of slots 110 in the strip 18 while the actuator 174 is slid into a slot 112 in the selected cassette engaging feature 16 and a hook 180 on the flexible end 170 of the tray engaging feature 168 moves into an aperture 116 in the cassette engaging feature 16. A person of ordinary skill in the art will now understand that the hook 180 is biased into the aperture 116 by the flexible end 170 and such that the cassette 12 is securely held to the tray 14. Similarly, in order to release the cassette 12 from the tray 14, the actuator 174 is depressed thereby forcing the hook 180 out of the aperture 116 in the cassette engaging feature 16 thereby allowing the cassette 12 to be retracted from the tray 14.

Although the present invention has been described hereinabove by way of specific embodiments thereof, it can be modified, without departing from the spirit and nature of the subject invention as defined in the appended claims.

1. A fiber optic cassette configured to be arranged on a tray comprising a plurality of cassette engaging features, the cassette comprising:
a cassette portion comprising a plurality of optic fiber receptacles arranged along a front end, a multifiber receptacle along a back end and a pair of opposed side edges connecting the front end and the back end;
a reversible securing portion;
wherein each of the optic fiber receptacles is structurally configured to terminate a first end of an optic fiber, and the multifiber receptacle is structurally configured to terminate a second end of a plurality of optic fibers extending from the optic fiber receptacles;
wherein the front end, back end and the opposed side edges together define a cable assembly receiving portion;
wherein the second ends are encased in a cable jacket,
wherein a casing is lower pressure molded over a free end of the cable jacket and a middle portion of each of the plurality of optic fibers;
wherein the first ends stand free of and are equally spaced along a first casing end of the casing and the second ends stand free of a second casing end opposite the first casing end;
wherein a pair of parallel slot-like apertures are molded in the casing towards a center thereof;
wherein a main part of the reversible securing portion is structurally configured to fit sideways across the cassette portion towards a center thereof, the main part comprising a first surface and a second surface opposite the first surface;
wherein a plurality of pairs of opposed flexible fingers extend away from the first surface and are structurally configured to releasingly engage in respective slots in the side edges of the cassette portion, one of each of the pairs of fingers positioned along each outer side edge of the main part;
wherein a pair of opposed casing engaging fingers are positioned towards a center of the main part extending at right angles away from the first surface and are structurally configured to be inserted into a corresponding one of the pair of parallel slot-like apertures molded in the casing;
wherein a tray engaging feature extending from the second surface is positioned off center of the main part and structurally configured to be engaged with one of the cassette engaging features;
wherein an actuator extends from a flexible end of the tray engaging feature through one of a pair of like apertures in the casing, one of the like apertures on either side of the pair of parallel slot-like apertures, the actuator for selectively disengaging the tray engaging feature from an engaged one of the cassette engaging features; and
wherein the reversible securing element is structurally configured to be secured on either side of the cassette portion by inserting the flexible fingers in respective ones of the outward facing slots while the casing engaging fingers are inserted into respective ones of the slot-like apertures and such that a free end of each of the fingers engages an outer surface of the casing holding the casing against the first surface and the actuator through an aligned one of the pair of like apertures and further wherein when the reversible securing portion is mounted on a first side of the cassette portion, the actuator is structurally configured to be actuated from a second side of the cassette portion.

2. The fiber optic cassette of claim 1, wherein each of the optic fibers comprises a first plug at the first end and each of the receptacles comprises a back-to-back receptacle, wherein each of the first plugs is structurally configured to be inserted into the respective one of the back-to-back receptacles.

3. The fiber optic cassette of claim 1, wherein all of the optic fibers comprise a second plug at the second end, wherein the second plug is structurally configured to be inserted into the multifiber receptacle.

4. A fiber optic cassette is configured to be arranged on a tray comprising a cassette engaging portion, the cassette comprising:
a cassette portion comprising a plurality of optic fiber receptacles arranged along a front portion thereof and a multifiber receptacle along a back portion thereof opposite the front portion and a pair of opposed side edge portions connecting the front portion and the back portion;
wherein each of the optic fiber receptacles is structurally configured to terminate a first end of an optic fiber, and the multifiber receptacle is structurally configured to terminate a second end of a plurality of optic fibers extending from the optic fiber receptacles;
wherein the front portion, the back portion, and the opposed side edge portions together define a cable assembly receiving portion;
wherein a tray engaging portion structurally configured to engage with a cassette portion of a tray extends away from the cable assembly receiving portion;
wherein a casing portion is molded over a middle portion of each of the plurality of optic fibers;
wherein the first end portions stand free of and are equally spaced along a first end portion of the casing portion and the second end portions stand free of a second end portion of the casing portion opposite the first end portion of the casing portion; and
wherein a casing engagement portion extends into the cable assembly receiving portion for retaining the casing portion within the cable assembly receiving portion.

5. The fiber optic cassette of claim 4, further comprising an actuating portion structurally configured to disengage the tray engaging portion from an engaged one of the cassette engaging portions.

6. The fiber optic cassette of claim 4, wherein the casing portion comprises a a receiving portion molded therein, wherein the casing engagement portion comprises an engagement portion structurally configured to be inserted into the receiving portion, and wherein upon insertion of each of the engagement portion into the receiving portion, the engagement portion is structurally configured to engage the receiving portion so as to retain the casing within the cable assembly receiving portion.

7. The fiber optic cassette of claim 4, further comprising a reversible securing portion:
wherein a main portion of the reversible securing portion is structurally configured to fit sideways across the cassette portion towards a center portion thereof, the main portion comprising a first surface portion facing the cable assembly receiving portion and a second surface portion opposite the first surface portion;
wherein the reversible securing portion is structurally configured to be secured on either side of the cassette portion;
wherein the casing engagement portion extends from the first surface portion; and
wherein the tray engaging portion extends from the second surface portion.

8. The fiber optic cassette of claim 7, wherein a pair of opposed flexible fingers are positioned along each outer side edge of the main part extending away from the first surface, wherein the opposed flexible fingers are structurally configured to releasingly engage in respective slots in the side edges of the cassette portion and wherein the reversible securing portion is structurally configured to be secured on either side of the cassette portion by inserting the flexible fingers in respective ones of the outward facing slots.

9. The fiber optic cassette of claim 7, wherein the casing portion comprises a pair of slot-like apertures molded therein, wherein a pair of opposed casing engaging fingers are positioned towards a center portion of the main part extending at right angles away from the first surface portion, wherein each of the casing engaging fingers are structurally configured to be inserted into a respective one of the slot-like apertures and wherein upon insertion of each of the fingers into the respective one of the slot-like apertures, each of the fingers engages the respective one of the slot-like aperture thereby retaining the casing within the cable assembly receiving portion.

10. The fiber optic cassette of claim 7, wherein the tray engaging portion extends away from the second surface portion.

11. The fiber optic cassette of claim 10, wherein the tray engaging portion is positioned off center of the main portion, wherein an actuating portion extends from a flexible end portion of the tray engaging portion through one of a pair of like apertures in the casing, one of the like apertures on either side of the pair of parallel slot-like apertures, the actuating portion for selectively disengaging the tray engaging portion from an engaged one of the cassette engaging portions.

12. The fiber optic cassette of claim 10, wherein the second end portions are encased in a cable jacket and wherein the casing portion is molded over a free end portion of the cable jacket.

13. A fiber optic cassette comprising:
a cassette portion comprising a plurality of optic fiber receptacles arranged along a front portion thereof and a multifiber receptacle along a back portion thereof opposite the front portion;
wherein the front portion and the back portion are structurally configured to define a cable assembly receiving portion there between;
wherein each of the optic fiber receptacles is structurally configured to terminate a first end portion of an optic fiber, and the multifiber receptacle is structurally configured to terminate a second end portion of a plurality of optic fibers extending from the optic fiber receptacles; and
wherein a middle portion of each of the plurality of optic fibers is within a casing portion and received within the cable assembly receiving portion.

14. The fiber optic cassette of claim 13, wherein the casing portion is molded over the middle portions of the plurality of optic fibers.

15. The fiber optic cassette of claim 13, wherein the first end portions stand free of and are equally spaced along a first end portion of the casing portion.

16. The fiber optic cassette of claim 13, wherein the second end portions stand free of a second end portion of the casing portion opposite the first end portion of the casing portion.

17. The fiber optic cassette of claim 13, wherein each of the optic fibers comprises a first plug portion at the first end portion, wherein each of the first plug portions is structurally configured to be inserted into the respective one of the receptacles.

18. The fiber optic cassette of claim 13, wherein all of the optic fibers comprise a second plug portion at the second end portion, wherein the second plug portion is structurally configured to be inserted into the multifiber receptacle.

19. The fiber optic cassette of claim 13, wherein the cassette is structurally configured to be arranged on a tray comprising a plurality of cassette engaging portions, and wherein a tray engaging portion structurally configured to engage with one of the cassette engaging portions extends away from the cable assembly receiving portion.

20. The fiber optic cassette of claim 13, further comprising a casing engagement portion structurally configured to engage the casing portion within the cable assembly receiving portion.
